(19) United States
(12) Patent Application Publication
(10) Pub. No.: US 2003/0150810 A1
(43) Pub. Date: Aug. 14, 2003

(54) Water purification system and water purification method

(76) Inventors: Naoki Hiro, Osaka-shi (JP); Motoki Kouchi, Ora-gun (JP); Tomohito Koizumi, Ota-shi (JP); Tsuyoshi Rakuma, Ora-gun (JP)

Correspondence Address: ARMSTRONG,WESTERMAN & HATTORI, LLP, 1725 K STREET, NW, SUITE 1000, WASHINGTON, DC, 20006, US

(21) Appl. No.: 10/336,861

(22) Filed: Jan. 6, 2003

(30) Foreign Application Priority Data
Feb. 13, 2002 (JP) 2002-35099
Jul. 29, 2002 (JP) 2002-219432

(51) Int. Cl. B01D 61/00

(52) U.S. Cl. 210/652; 210/669; 210/748; 210/806; 210/243; 210/321.6; 210/259

(57) ABSTRACT

An object of the present invention is to provide a water purification system capable of treating for-treatment water containing a nitrogen compound such as polluted ground water efficiently and achieving a reduction in size of the system. The water purification system comprises an electrodialyser for concentrating a nitrogen compound in polluted ground water as for-treatment water containing a nitrogen compound, a nitrogen treatment device for treating the nitrogen compound in the for-treatment water treated in the electrodialyser by electrolysis as an electrochemical process, the for-treatment water containing at least chloride ions, and a pump for returning the for-treatment water treated in the nitrogen treatment device to the electrodialyser.

### BACKGROUND OF THE INVENTION

1. Field of the Invention

The present invention relates to a water purification system and a water purification method which treat for-treatment water such as polluted ground water containing a nitrogen compound.

2. Description of the Related Art

In recent years, pollution of ground water caused by a water-soluble nitrate seeping into the soil from a chemical fertilizer or excrement of livestock has been regarded as a serious problem. It is known that if one takes in polluted ground water, the water causes neuropathy, cancer, or methemoglobinemia in the case of an infant. Therefore, particularly, early development of a technique of removing nitrate nitrogen contained in the ground water thoroughly is desired.

Meanwhile, as a system capable of removing nitrate nitrogen from ground water polluted by the nitrogen compound, a technique set forth on pages 944 and 945 in “Service Water and Waste Water Vol. 41 No. 10 (1999)” is known. In the system for removing nitrate nitrogen from the polluter ground water, firstly, the polluted ground water is treated in an electrodialyser so as to remove and concentrate nitrate nitrogen in the ground water, the treated water free from nitrate nitrogen is discharged as purified water or drinking water, and the waste water concentrated in the electrodialyser is treated by biological denitrification.

However, to remove nitrate nitrogen by the biological denitrification employed in the above system, biological treatment by denitrifying bacteria under anaerobic conditions is employed. The majority of the denitrifying bacteria are heterotrophic bacteria and require organic matter in order to proliferate. For this reason, when waste water containing little organic matter such as inorganic waste water is to be treated, addition of a hydrogen donor such as methanol and installation of an anaerobic purification tank are essential. Hence, problems arise with respect to a place and costs to install the tank.

Further, there is also a problem that since the denitrifying bacteria are significantly influenced by a surrounding temperature environment as well as components contained in the waste water, the activities of the bacteria decrease particularly during a winter season when the temperature is low, thereby lowering a denitrifying effect, resulting in unstable efficiency of the treatment of the waste water. In addition, there is another problem that since the waste water concentrated in the electrodialyser has an increased concentration of the nitrogen compound (nitrate nitrogen), treatment time is further extended with the biological treatment.

### SUMMARY OF THE INVENTION

Under the circumstances, the present invention has been conceived so as to solve the technical problems of the prior art. An object of the present invention is to provide a water purification system and a water purification method which are capable of treating for-treatment water containing a nitrogen compound such as polluted ground water efficiently and achieving a reduction in size of the system.

A water purification system of the present invention comprises concentration means for concentrating a nitrogen compound in for-treatment water containing the nitrogen compound, nitrogen treatment means for treating the nitrogen compound in the for-treatment water treated by the concentration means by an electrochemical process, the for-treatment water containing at least halide ions, and returning means for returning the for-treatment water treated by the nitrogen treatment means to the concentration means.

According to the present invention, since the water purification system comprises concentration means for concentrating a nitrogen compound in for-treatment water containing the nitrogen compound and nitrogen treatment means for treating the nitrogen compound in the for-treatment water treated by the concentration means and containing at least halide ions by an electrochemical process, the nitrogen compound in the for-treatment water can be removed and concentrated by the concentration means, and the resulting for-treatment water free from the nitrogen compound can be discharged as purified water or drinking water.

Further, in the for-treatment water concentrated by the concentration means and containing at least halide ions, hypohalogenous acid can be produced by an electrochemical process in the nitrogen treatment means. Thereby, the nitrogen compound can be removed efficiently.

Accordingly, unlike the prior art, the nitrogen compound such as nitrate nitrogen contained in the for-treatment water can be removed efficiently without adding a special additive such as methanol to the for-treatment water, so that ease of maintenance can be improved.

Further, according to the present invention, since the nitrogen compound such as nitrate nitrogen is not treated by biological treatment, control of temperatures of bacteria and the like can be obviated, and the size of the system itself can be reduced, so that costs can be reduced.

Further, since the water purification system of the present invention comprises returning means for returning the for-treatment water treated by the nitrogen treatment means to the concentration means, the for-treatment water treated by the nitrogen treatment means can be treated by the concentration means again without being discharged as it is, so that water purification treatment suited for the environment can be implemented.

Further, since at least halide ions are contained in the for-treatment water to be treated by the nitrogen treatment means, hypohalogenous acid is contained in the for-treatment water treated by the electrochemical process (electrolysis). Therefore, by returning the for-treatment water containing hypohalogenous acid to the concentration means by the returning means, for-treatment water to be treated in the concentration means can be sterilized. Consequently, the for-treatment water treated in the concentration means can be discharged as purified water or drinking water which is favorable from a sanitary standpoint.

Further, in that case, hypohalogenous acid is contained in the for-treatment water concentrated in the concentration means. Thus, even when halide ions are not contained in for-treatment water which is to be newly treated in the concentration means, the need for adding halide ions can be obviated, so that ease of maintenance can be improved.

Further, in the water purification system of the present invention, the nitrogen treatment means treats 200 to 500 mg/L of nitrate nitrogen contained in the for-treatment water as the nitrogen compound so as to adjust the content of nitrate nitrogen in the for-treatment water to 50 to 100 mg/L.

According to the present invention, since the nitrogen treatment means treats 200 to 500 mg/L of nitrate nitrogen contained in the for-treatment water as the nitrogen compound so as to adjust the content of nitrate nitrogen in the for-treatment water to 50 to 100 mg/L, denitrification can be carried out with high denitrification efficiency, so that the efficiency of the treatment can be further improved.

Further, in the water purification system of the present invention, the concentration means treats the nitrogen compound in the for-treatment water treated in filtration means.

According to the present invention, since the concentration means treats the nitrogen compound in the for-treatment water treated in the filtration means, the nitrogen compound can be concentrated in the concentration means after solid components contained in the for-treatment water are removed in the filtration means, whereby ease of maintenance of the concentration means can be improved.

Further, when iron ions or manganese ions are contained in the for-treatment water, hypohalogenous acid produced in the nitrogen treatment means can react with the iron ions and manganese ions so as to produce an iron hydroxide which is hardly soluble in water and hydrated manganese dioxide. Thus, the iron ions and manganese ions contained in the for-treatment water can be removed by the filtration means as the iron hydroxide and hydrated manganese dioxide.

Further, in the water purification system of the present invention, the concentration means comprises an electrodialyser.

According to the present invention, since the concentration means comprises the electrodialyser, the nitrogen compound contained in the for-treatment water can be concentrated easily and continuously.

Further, in the water purification system of the present invention, the concentration means comprises reverse osmosis membrane equipment.

According to the present invention, since the concentration means comprises the reverse osmosis membrane equipment, the nitrogen compound contained in the for-treatment water can be concentrated easily and continuously.

Further, in the water purification system of the present invention, the concentration means comprises an ion exchange resin and means for restoring the ion exchange resin.

According to the present invention, since the concentration means comprises the ion exchange resin and the means for restoring the ion exchange resin, for-treatment water containing a low concentration of nitrogen compound can be passed through the ion exchange resin so as to be discharged as purified water free from the nitrogen compound. Further, by passing restoration water through the ion exchange resin whose ion exchange ability has been lowered due to the nitrogen compound stuck thereto, the ion exchange ability of the ion exchange resin can be restored, and the used restoration water contains the nitrogen compound in high concentration. Thus, the nitrogen compound contained in the for-treatment water can be concentrated easily and continuously.

Further, in the water purification system of the present invention, as a metallic material constituting a cathode of the nitrogen treatment means, a conductive material containing or covered with an element in the group Ib or IIb of the periodic table is used, and as a conductive material constituting an anode, an insoluble material or carbon is used.

According to the present invention, since a conductive material containing or covered with an element in the group Ib or IIb of the periodic table is used as the metallic material constituting the cathode of the nitrogen treatment means, and an insoluble material or carbon is used as the conductive material constituting the anode, reactions of reducing nitrate nitrogen in the for-treatment water to nitrite nitrogen and to ammonia can be accelerated so as to shorten time required for the reduction reactions, and even a low concentration of nitrogen compound can be removed. Thereby, the efficiency of the treatment of the nitrogen compound is improved.

Further, a water purification method of the present invention comprises a concentration step of concentrating a nitrogen compound in for-treatment water containing the nitrogen compound, a nitrogen treatment step of treating the nitrogen compound in the for-treatment water treated in the concentration step by an electrochemical process, the for-treatment water containing at least halide ions, and a returning step of returning the for-treatment water treated in the nitrogen treatment step to the concentration step.

According to the present invention, since the water purification method comprises the concentration step of concentrating a nitrogen compound in for-treatment water containing the nitrogen compound and the nitrogen treatment step of treating the nitrogen compound in the for-treatment water treated in the concentration step and containing at least halide ions by an electrochemical process, the nitrogen compound in the for-treatment water can be removed and concentrated in the concentration step, and the resulting for-treatment water free from the nitrogen compound can be discharged as purified water or drinking water.

Further, in the for-treatment water concentrated in the concentration step and containing at least halide ions, hypohalogenous acid can be produced by an electrochemical process in the nitrogen treatment step. Thereby, the nitrogen compound can be removed efficiently.

Accordingly, unlike the prior art, the nitrogen compound such as nitrate nitrogen contained in the for-treatment water can be removed efficiently without adding a special additive such as methanol to the for-treatment water, so that ease of maintenance can be improved.

Further, according to the present invention, since the nitrogen compound such as nitrate nitrogen is not treated by biological treatment, control of temperatures of bacteria and the like can be obviated, so that costs can be reduced.

Further, since the water purification method of the present invention further comprises the returning step of returning the for-treatment water treated in the nitrogen treatment step to the concentration step, the for-treatment water treated in the nitrogen treatment step can be treated again in the concentration step without being discharged as it is, so that water purification treatment suited for the environment can be implemented.

Further, since at least halide ions are contained in the for-treatment water to be treated in the nitrogen treatment step, hypohalogenous acid is contained in the for-treatment water treated by the electrochemical process (electrolysis). Therefore, by returning the for-treatment water containing hypohalogenous acid to the concentration step in the returning step, for-treatment water to be treated in the concentration step can be sterilized. As a result, the for-treatment water treated in the concentration step can be discharged as purified water or drinking water which is favorable from a sanitary standpoint.

Further, in that case, hypohalogenous acid is contained in the for-treatment water concentrated in the concentration step. Thus, even when halide ions are not contained in for-treatment water which is to be newly treated in the concentration step, there is no need to add halide ions, so that ease of maintenance can be improved.

Further, in the water purification method of the present invention, in the nitrogen treatment step, 200 to 500 mg/L of nitrate nitrogen contained in the for-treatment water as the nitrogen compound is treated so as to adjust the content of nitrate nitrogen in the for-treatment water to 50 to 100 mg/L.

According to the present invention, since 200 to 500 mg/L of nitrate nitrogen contained in the for-treatment water as the nitrogen compound is treated in the nitrogen treatment step so as to adjust the content of nitrate nitrogen in the for-treatment water to 50 to 100 mg/L, denitrification can be carried out with high denitrification efficiency, so that the efficiency of the treatment can be further improved.

Further, in the water purification method of the present invention, in the concentration step, the nitrogen compound in the for-treatment water treated in a filtration step is treated.

According to the present invention, since the nitrogen compound in the for-treatment water treated in the filtration step is treated in the concentration step, the nitrogen compound can be concentrated in the concentration step after solid components contained in the for-treatment water are removed in the filtration step, whereby ease of maintenance in the concentration step can be improved.

Further, when iron ions and manganese ions are contained in the for-treatment water, hypohalogenous acid produced in the nitrogen treatment step can react with the iron ions and manganese ions so as to produce an iron hydroxide which is hardly soluble in water and hydrated manganese dioxide. Thus, the iron ions and manganese ions contained in the for-treatment water can be removed in the filtration step as the iron hydroxide and hydrated manganese dioxide.

Further, in the water purification method of the present invention, the concentration step is carried out by means of an electrodialyser.

According to the present invention, since the concentration step is carried out by means of the electrodialyser, the nitrogen compound contained in the for-treatment water can be concentrated easily and continuously.

Further, in the water purification method of the present invention, the concentration step is carried out by means of reverse osmosis membrane equipment.

According to the present invention, since the concentration step is carried out by means of the reverse osmosis membrane equipment, the nitrogen compound contained in the for-treatment water can be concentrated easily and continuously.

Further, in the water purification method of the present invention, the concentration step comprises an ion exchange step of treating the nitrogen compound in the for-treatment water with an ion exchange resin, and a restoration step of restoring the used ion exchange resin after completion of the ion exchange step.

According to the present invention, since the concentration step comprises the ion exchange step of treating the nitrogen compound in the for-treatment water with an ion exchange resin and the restoration step of restoring the used ion exchange resin after completion of the ion exchange step, for-treatment water containing a low concentration of nitrogen compound can be passed through the ion exchange resin in the ion exchange step so as to be discharged as purified water free from the nitrogen compound. Further, in the restoration step, by passing restoration water through the ion exchange resin whose ion exchange ability has been lowered due to the nitrogen compound stuck thereto, the ion exchange ability of the ion exchange resin can be restored, and the used restoration water contains the nitrogen compound in high concentration. Thus, the nitrogen compound contained in the for-treatment water can be concentrated easily.

Further, in the water purification method of the present invention, in the nitrogen treatment step, as a metallic material constituting a cathode, a conductive material containing or covered with an element in the group Ib or IIb of the periodic table is used, and as a conductive material constituting an anode, an insoluble material or carbon is used.

According to the present invention, since a conductive material containing or covered with an element in the group Ib or IIb of the periodic table is used as the metallic material constituting the cathode in the nitrogen treatment step, and an insoluble material or carbon is used as the conductive material constituting the anode in the nitrogen treatment step, reactions of reducing nitrate nitrogen in the for-treatment water to nitrite nitrogen and to ammonia can be accelerated so as to shorten time required for the reduction reactions, and even a low concentration of nitrogen compound can be removed. Thereby, the efficiency of the treatment of the nitrogen compound is improved.

### BRIEF DESCRIPTION OF THE DRAWINGS

FIG. 1 is an explanatory diagram showing an overview of a water purification system of the present invention.

FIG. 2 is an explanatory diagram showing an overview of a nitrogen treatment device.

FIG. 3 is an explanatory diagram showing an overview of a water purification system of another embodiment.

FIG. 4 is an explanatory diagram showing an overview of a water purification system of still another embodiment.

FIG. 5 is an explanatory diagram showing an overview of a water purification system of still another embodiment.

### DETAILED DESCRIPTION OF THE PREFERRED EMBODIMENT

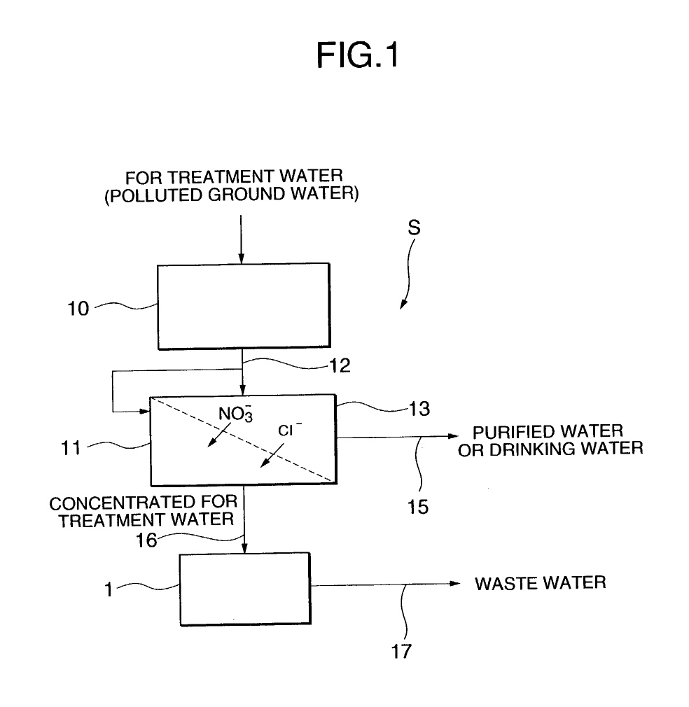

Hereinafter, embodiments of the present invention will be described with reference to the drawings. FIG. 1 is an explanatory diagram showing an overview of a water purification system S adopting a water purification method of the present invention. For-treatment water to be treated by the water purification system S in the present embodiment is ground water polluted by a water-soluble nitrate, i.e., nitrate nitrogen, which has seeped into the soil from a chemical fertilizer or excrement of livestock, for example. Further, the for-treatment water used in the present embodiment is polluted ground water containing 10 to 30 mg/L of nitrate nitrogen. In addition, since the for-treatment water is polluted ground water, it contains at least chloride ions an example of halide ions.

The water purification system S comprises a reservoir 10 for reserving polluted ground water as for-treatment water, an electrodialyser 11 as concentration means for concentrating a nitrogen compound in for-treatment water in a concentration step, and a nitrogen treatment device 1 as nitrogen treatment means for treating nitrogen in a nitrogen treatment step.

The reservoir 10 is connected to a for-treatment water storage tank 13 which constitutes the electrodialyser 11 via a pipe 12. Further, to the tank 13, a pipe 15 for discharging water purified by the electrodialyser 11 out of the tank 13 is connected. To the tank 13 is also connected a pipe 16 for transferring for-treatment water concentrated in a manner to be described in detail later to the nitrogen treatment device 1. To the nitrogen treatment device 1 is connected a pipe 17 for discharging for-treatment water subjected to nitrogen treatment out of the nitrogen treatment device 1.

The electrodialyser 11 as concentration means in the present embodiment is based on so-called electrodialysis in which for-treatment water is electrically concentrated (separated) and recovered by use of a plurality of anion exchange membranes which selectively permit only anions to permeate therethrough and a plurality of cation exchange membranes which selectively permit only cations to permeate therethrough, the anion exchange membranes and the cation exchange membranes being arranged alternately. The anion exchange membranes and the cation exchange membranes are not shown. A description about details of the technique will be omitted herein since it is already disclosed on pages 152 to 156 of “Unit Operations for Removal of Nitrogen and Phosphorus” in “Research Report on Technique for Prevention of Eutrophication in Closed Expanse of Water, 1997, Rational Technique for Treatment of Nitrogen and Phosphorus in Industrial Waste Water”.

In the present embodiment, firstly, in the concentration step, for-treatment water reserved in the reservoir 10 is transferred into the storage tank 13 of the electrodialyser 11 via the pipe 12, and potentials are applied to electrodes in the electrodialyser 11 which are not shown. As a result, for-treatment water with a content of nitrate nitrogen of 10 to 30 mg/L which is treated in an amount of, for example, 110 tons per day is separated into 100 tons of purified water containing 5 to 8 mg/L of nitrate nitrogen and 10 tons of concentrated for-treatment water containing 200 to 500 mg/L of nitrate nitrogen. At this point, chloride ions contained in polluted ground water as the for-treatment water move into the concentrated for-treatment water.

Consequently, the water purified by the electrodialyser 11 in the concentration step can satisfy the water quality standard that the content of nitrate nitrogen must be not higher than 10 mg/L and can be provided as drinking water.

Meanwhile, the for-treatment water concentrated by the electrodialyser 11 is transferred to the nitrogen treatment device 1 via the pipe 16.

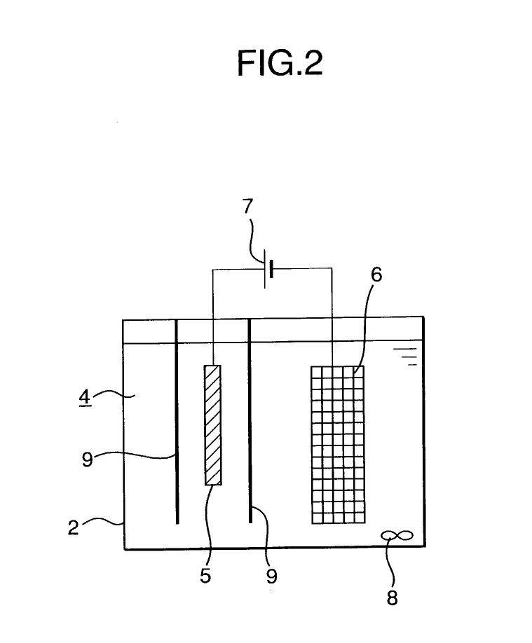

Next, the nitrogen treatment device 1 will be described with reference to FIG. 2. The nitrogen treatment device 1 in the present embodiment is employed for denitrification of for-treatment water by an electrochemical process (electrolysis) and comprises a treating vessel 2 which constitutes a treating chamber 4 having an inlet for allowing the concentrated for-treatment water to flow into the chamber 4 via the pipe 16 and an outlet, a pair of electrodes, i.e., an anode 5 and a cathode 6, which are disposed to confront each other so as to be at least partially immersed in the concentrated for-treatment water in the treating chamber 4, a power supply 7 for energizing the electrodes 5 and 6, and a controller for controlling the power supply 7. The inlet, the outlet and the controller are not shown. Further, reference numeral 8 in FIG. 2 denotes a stirring bar as stirring means for stirring the for-treatment water in the treating vessel 2.

The cathode 6 is formed of a conductive material containing or covered with an element in the group Ib or IIb of the periodic table, such as zinc, copper, silver or brass which is an alloy of zinc and copper, while the anode 5 is an insoluble electrode comprising an insoluble metal such as platinum, iridium, palladium or an oxide thereof or is made of carbon.

Further, a cylindrical shielding member 9 is provided between the anode 5 and the cathode 6 such that it surrounds the anode 5. The shielding member 9 is formed of a non-conductive member such as glass fiber meshes or plastic meshes and can prevent oxygen bubbles produced from the anode 5 from moving toward the cathode 6. In this case, ions present around the anode 5 can pass through the shielding member 9 and move toward the cathode 6. Further, the shielding member 9 protects the anode 5 from being influenced by agitation caused by movement of the polluted water or the stirring bar 8.

With the constitution described above, in the nitrogen treatment step, the for-treatment water concentrated in the concentration step is reserved in the treating vessel 2 of the nitrogen treatment device 1, and the controller turns on the power supply 7 so as to energize the cathode 6 and the anode 5, thereby electrolyzing the for-treatment water. On the cathode 6 side, nitrate ions contained in the concentrated for-treatment water are converted into nitrite ions through a reduction reaction (reaction formula A). Then, the nitrite ions produced through the reduction reaction of the nitrate ions are further converted into ammonia through another reduction reaction (reaction formula B). The reaction formulae A and B are shown below.

NO₃⁻+H₂O+2e⁻→NO₂⁻+2OH⁻ Reaction Formula A

NO₂⁻+5H₂O+6e⁻→NH₃(aq)+7OH⁻ Reaction Formula B

Meanwhile, on the anode 5 side, since at least chloride ions are present in the concentrated for-treatment water as described above, hypochlorous acid as an example of hypohalogenous acid and ozone or active oxygen are produced from the surface of the anode 5. As a result, ammonia in the concentrated for-treatment water is denitrified, thereby producing a nitrogen gas (reaction formula C). The reaction formula C is shown below.

2NH₃+3HClO→N₂↑+3HCl+3H₂O Reaction Formula C

In this case, when the content of the chloride ions in the concentrated for-treatment water is lower than a predetermined content such as 100 mg/L, additional chloride ions such as potassium chloride or sodium chloride are added to the concentrated for-treatment water by chloride ion adjusting means. Thereby, production of hypochlorous acid (hypohalogenous acid) in the concentrated for-treatment water by electrolysis is accelerated, so that ammonia in the concentrated for-treatment water can be denitrified efficiently.

However, when the content of the chloride ions in the for-treatment water prior to concentration is not lower than 100 mg/L, it is not necessary to adjust the content of the chloride ions by the chloride ion adjusting means.

Thereby, the nitrogen compound in the concentrated for-treatment water containing 200 to 500 mg/L of nitrate nitrogen can be removed efficiently in the nitrogen treatment device 1, and the resulting for-treatment water can be discharged as for-treatment water containing 10 to 30 mg/L of nitrate nitrogen.

Thus, unlike the prior art, the nitrogen compound such as nitrate nitrogen contained in the for-treatment water can be removed efficiently without adding a special additive such as methanol to the for-treatment water, so that ease of maintenance can be improved.

Further, since unlike the prior art, the nitrogen compound such as nitrate nitrogen is not treated by biological treatment, control of temperatures of bacteria and the like can be obviated, and the size of the water purification system itself can be reduced, so that costs can be reduced.

Furthermore, in the present embodiment, since the for-treatment water concentrated to have a content of the nitrogen compound of 200 to 500 mg/L by the electrodialyser 11 in the concentration step is electrolyzed by the nitrogen treatment device 1 in the nitrogen treatment step, the nitrogen compound can be removed efficiently.

More specifically, when for-treatment water having a relatively low content of nitrogen compound, e.g., 50 mg/L of nitrogen compound, is treated by a direct electrochemical process (electrolysis) so as to reduce the content of the nitrogen compound to 10 mg/L, a current efficiency of 35% and a voltage of 8V are required. Meanwhile, when for-treatment water concentrated by the electrodialyser 11 to have a content of nitrogen compound of 50 mg/L is treated in the same manner as in the present embodiment so as to reduce the content of the nitrogen compound to 10 mg/L, denitrification can be carried out at a current efficiency of 70% and a voltage of 5V. Thus, water purification treatment can be implemented remarkably efficiently.

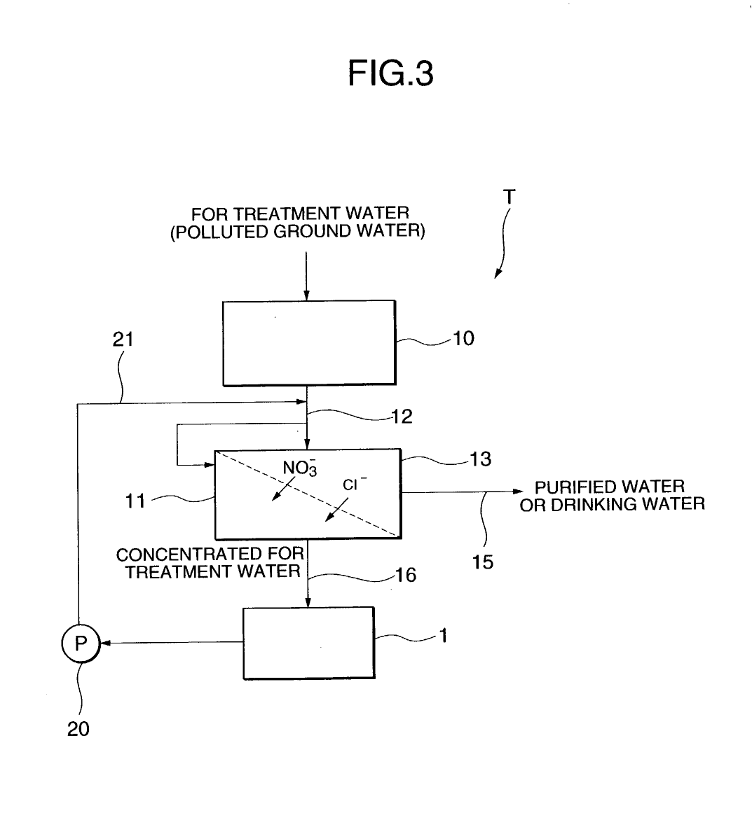

Next, a water purification system T as another embodiment will be described with reference to FIG. 3. In FIG. 3, components represented by the same reference numerals as found in FIG. 1 have the same or similar functions as those of components in FIG. 1 which are represented by the reference numerals. As in the case of the water purification system S of the foregoing embodiment, the water purification system T in the present embodiment comprises a reservoir 10 for reserving polluted ground water as for-treatment water, an electrodialyser 11 as concentration means for carrying out a step of concentrating a nitrogen compound in for-treatment water, and a nitrogen treatment device 1 as nitrogen treatment means for carrying out a nitrogen treatment step. In addition to these, the water purification system T further comprises a pump 20 as returning means for carrying out a step of returning for-treatment water treated in the nitrogen treatment device 1 to the electrodialyser 11.

That is, the water purification system T in the present embodiment does not have the pipe 17 used in the foregoing embodiment for discharging for-treatment water treated in the nitrogen treatment device 1 out of the system. Instead, one end of a pipe 21 is connected to the nitrogen treatment device 1 via the pump 20. The other end of the pipe 21 is connected to a pipe 12 which connects the reservoir 10 to the electrodialyser 11.

With the above constitution, upon operation of the water purification system T, for-treatment water reserved in the reservoir 10 is transferred into a storage tank 13 of the electrodialyser 11 via the pipe 12. Then, the concentration step which has been described in detail above is carried out in the electrodialyser 11 so as to separate the for-treatment water into purified water containing 5 to 8 mg/L of nitrate nitrogen and concentrated for-treatment water containing 200 to 500 mg/L of nitrate nitrogen.

Consequently, in the present embodiment as well, the water purified by the electrodialyser 11 can satisfy the water quality standard that the content of nitrate nitrogen must be not higher than 10 mg/L and can be provided as drinking water.

Meanwhile, the for-treatment water concentrated by the electrodialyser 11 is transferred to the nitrogen treatment device 1 via the pipe 16. As in the foregoing embodiment, in the nitrogen treatment device 1, when a controller turns on a power supply 7 so as to energize a cathode 6 and an anode 5 in the nitrogen treatment step, nitrate ions contained in the concentrated for-treatment water are converted into nitrite ions through a reduction reaction at the cathode 6. Then, the nitrite ions produced through the reduction reaction of the nitrate ions are converted into ammonia through another reduction reaction.

Meanwhile, on the anode 5 side, since at least chloride ions are contained in the concentrated for-treatment water as described above, hypochlorous acid and ozone or active oxygen are produced from the surface of the anode 5. As a result, ammonia in the concentrated for-treatment water is denitrified, thereby producing a nitrogen gas.

Thereby, the nitrogen compound in the concentrated for-treatment water containing 200 to 500 mg/L of nitrate nitrogen can be removed efficiently in the nitrogen treatment device 1, and the resulting for-treatment water whose content of nitrate nitrogen has been reduced to 10 to 30 mg/L by the nitrogen removal treatment is sent to the pipe 12 connecting the reservoir 10 to the electrodialyser 11, by the pump 20 as returning means via the pipe 21 in the returning step. Then, together with untreated for-treatment water in the reservoir 10, the resulting for-treatment water is transferred into the storage tank 13 of the electrodialyser 11.

Thus, the for-treatment water treated in the nitrogen treatment device 1 is not discharged out of the system as it is, and the nitrogen compound in the for-treatment water is concentrated in the electrodialyser 11 again. As a result, the for-treatment water can be provided as purified water (or drinking water). Thereby, waste water which cannot be discharged out of the system as purified water can be recycled, so that water purification treatment suited for the environment can be implemented.

The for-treatment water treated in the nitrogen treatment device 1 is sent back to the electrodialyser 11 by the pump 20 via the pipes 21 and 12 in the returning step. In this regard, since chloride ions are contained in the for-treatment water prior to the treatment in the nitrogen treatment device 1, hypochlorous acid is contained in the for-treatment water treated in the nitrogen treatment device 1.

Therefore, not only the for-treatment water treated in the nitrogen treatment device 1 but also for-treatment water in the reservoir 10 which merges into the for-treatment water in the pipe 12 can be sterilized by hypochlorous acid.

Thus, the for-treatment water to be transferred to the electrodialyser 11 can be concentrated and separated after sterilized with hypochlorous acid in advance, so that purified water can be provided in a sanitarily favorable condition.

Further, hypochlorous acid contained in the for-treatment water is concentrated again in the electrodialyser 11 and transferred to the nitrogen treatment device 1 together with the for-treatment water. Therefore, as described above, once the content of the chloride ions in the for-treatment water is adjusted to not lower than a certain content (such as 100 mg/L) at the start of the treatment, it is not necessary to add additional chloride ions, so that a complicated maintenance procedure can be avoided.

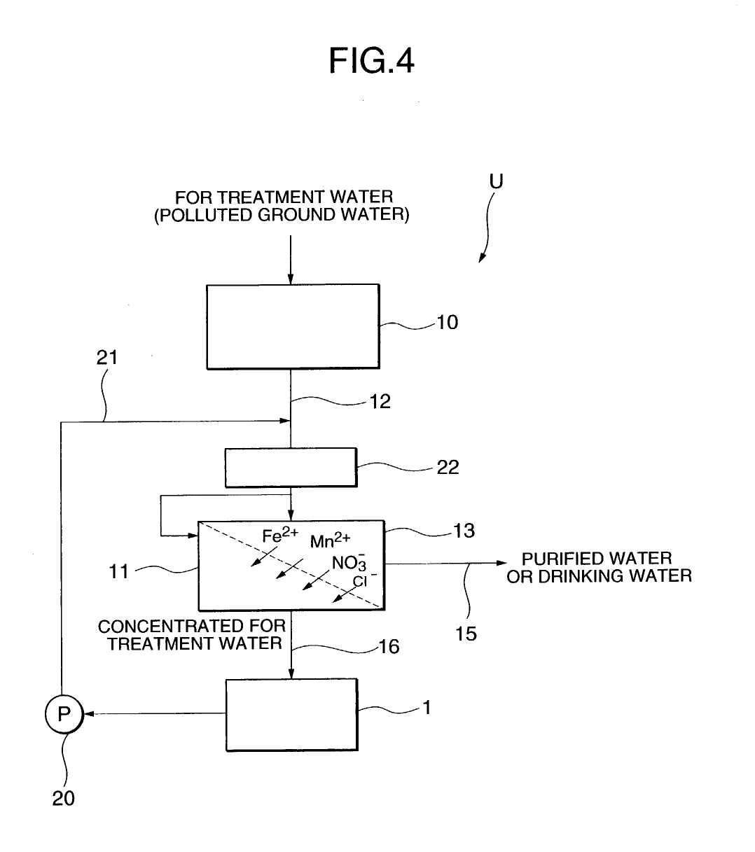

Next, a water purification system U as still another embodiment will be described with reference to FIG. 4. In FIG. 4, components represented by the same reference numerals as found in FIG. 1 have the same or similar functions as those of components in FIG. 1 which are represented by the reference numerals. As in the case of the water purification system T of the foregoing embodiment, the water purification system U in the present embodiment comprises a reservoir 10 for reserving polluted ground water as for-treatment water, an electrodialyser 11 as concentration means for carrying out a step of concentrating a nitrogen compound in for-treatment water, a nitrogen treatment device 1 as nitrogen treatment means for carrying out a nitrogen treatment step, and a pump 20 as returning means for carrying out a step of returning for-treatment water treated in the nitrogen treatment device 1 to the electrodialyser 11. In addition to these, the water purification system U further comprises a sand filter 22 as filtration means for carrying out a filtration step. The sand filter 22 is interposed between the reservoir 10 and the electrodialyser 11.

To be more specific, in the water purification system U in the present embodiment, a pipe 21 for transferring for-treatment water treated in the nitrogen treatment device 1 to the electrodialyser 11 is connected to the upstream side of a pipe 12 for transferring for-treatment water from the reservoir 10 to the electrodialyser 11, and the sand filter 22 is situated downstream from the portion where the pipe 21 is connected.

With the above constitution, upon operation of the water purification system U, in the filtration step, for-treatment water reserved in the reservoir 10 flows into the sand filter 22 via the pipe 12. Thereby, solid components contained in the for-treatment water which has flown into the sand filter 22 can be removed (or filtered out).

The for-treatment water filtered in the sand filter 22 is then transferred into a storage tank 13 of the electrodialyser 11 via the pipe 12 situated downstream from the sand filter 22. For the transferred for-treatment water, the concentration step which has been described in detail above is carried out in the electrodialyser 11. Thereby, the transferred for-treatment water is separated into purified water containing 5 to 8 mg/L of nitrate nitrogen and concentrated for-treatment water containing 200 to 500 mg/L of nitrate nitrogen.

Consequently, in the present embodiment as well, the water purified by the electrodialyser 11 can satisfy the water quality standard that the content of nitrate nitrogen must be not higher than 10 mg/L and can be provided as drinking water.

Meanwhile, the for-treatment water concentrated by the electrodialyser 11 is transferred to the nitrogen treatment device 1 via a pipe 16. As in the foregoing embodiment, in the nitrogen treatment device 1, when a controller turns on a power supply 7 so as to energize a cathode 6 and an anode 5 in the nitrogen treatment step, nitrate ions contained in the concentrated for-treatment water are converted into nitrite ions through a reduction reaction at the cathode 6. Then, the nitrite ions produced through the reduction reaction of the nitrate ions are converted into ammonia through another reduction reaction.

Meanwhile, on the anode 5 side, since at least chloride ions are contained in the concentrated for-treatment water as described above, hypochlorous acid and ozone or active oxygen are produced from the surface of the anode 5. As a result, ammonia in the concentrated for-treatment water is denitrified, thereby producing a nitrogen gas.

Thereby, the nitrogen compound in the concentrated for-treatment water containing 200 to 500 mg/L of nitrate nitrogen can be removed efficiently in the nitrogen treatment device 1, and the resulting for-treatment water whose content of nitrate nitrogen has been reduced to 10 to 30 mg/L by the nitrogen removal treatment can be sent back to the electrodialyser 11.

The for-treatment water treated in the nitrogen treatment device 1 is sent back to the electrodialyser 11 by the pump 20 via the pipes 21 and 12 in the returning step. In this regard, when at least 100 mg/L of chloride ions are contained in the for-treatment water prior to the treatment in the nitrogen treatment device 1 as described above, a large amount of hypochlorous acid is contained in the for-treatment water treated in the nitrogen treatment device 1.

Therefore, not only the for-treatment water treated in the nitrogen treatment device 1 but also for-treatment water in the reservoir 10 which merges into the for-treatment water in the pipe 12 can be sterilized by hypochlorous acid.

Thus, the for-treatment water to be transferred to the electrodialyser 11 can be concentrated and separated after sterilized with hypochlorous acid in advance, so that purified water can be provided in a sanitarily favorable condition.

Further, hypochlorous acid contained in the for-treatment water is concentrated again in the electrodialyser 11 and transferred to the nitrogen treatment device 1 together with the for-treatment water. Therefore, once the content of the chloride ions in the for-treatment water is adjusted to not lower than a certain content (such as 100 mg/L) at the start of the treatment, it is not necessary to add additional chloride ions, so that a complicated maintenance procedure can be avoided.

Furthermore, when iron ions and manganese ions are contained in the polluted ground water as the for-treatment water to be treated in the present embodiment, these iron ions and manganese ions are also concentrated in the electrodialyser 11 and transferred to the nitrogen treatment device 1 together with the concentrated for-treatment water. Since a large amount of hypochlorite is present in the nitrogen treatment device 1 as described above, the iron ions and manganese ions react with these hypochlorites (as shown by reaction formula D and reaction formula E) so as to produce iron hydroxide (III) which is hardly soluble in water and hydrated manganese dioxide. The reaction formulae D and E are shown below.

2Fe²⁺+NaClO+5H₂O→2Fe(OH)₃+NaCl+4H⁺ Reaction Formula D

Mn²⁺+NaClO+2H₂O→MnO₂.H₂O+NaCl+2H⁺ Reaction Formula E

The for-treatment water containing iron hydroxide (III) and hydrated manganese dioxide produced in the nitrogen treatment device 1 is sent to the pipe 12 connecting the reservoir 10 to the electrodialyser 11 by the pump 20 via the pipe 21.

Since the pipe 21 is connected to the pipe 12 upstream from the sand filter 22 installed in the pipe 12, the for-treatment water containing the hypochlorite (hypohalogenite) and sent through the pipe 21 merges with for-treatment water sent from the reservoir 10. Iron ions and manganese ions contained in the for-treatment water sent from the reservoir 10 also produce iron hydroxide (III) which is hardly soluble in water and hydrated manganese dioxide.

Then, the iron hydroxide and hydrated manganese dioxide thus produced in the for-treatment water are filtered out in the sand filter 22. Thereby, the iron ions and manganese ions contained in the for-treatment water can also be removed efficiently, so that the efficiency of purification of for-treatment water can be improved.

In the above-described embodiment, in the nitrogen treatment device 1, the concentrated for-treatment water containing 200 to 500 mg/L of nitrate nitrogen is denitrified by the electrochemical process (electrolysis) so as to attain a nitrate nitrogen content of 10 to 30 mg/L. Then, the denitrified for-treatment water is sent back to the electrodialyser 11 by the pump 20, and the resulting concentrated for-treatment water containing 200 to 500 mg/L of nitrate nitrogen is then denitrified by an electrochemical process (electrolysis) so as to attain a nitrate nitrogen content of 50 to 100 mg/L. Thereafter, the denitrified for-treatment water may be sent back to the electrodialyser 11 again so as to concentrate the nitrogen compound together with another for-treatment water. In this case, as described above, denitrification can be carried out with high denitrification efficiency, so that the efficiency of the treatment can be further improved.

Further, in each of the foregoing embodiments, the electrodialyser 11 is used as the concentration means. Thus, the nitrogen compound contained in the for-treatment water can be concentrated easily and continuously. In addition, to attain the same effect, reverse osmosis membrane equipment may be used as the concentration means.

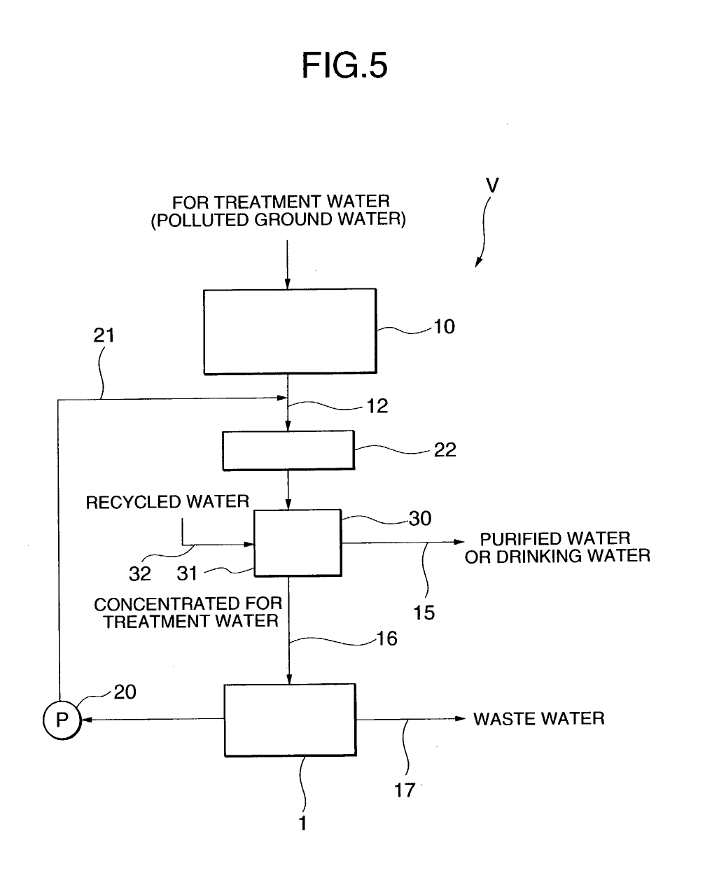

Next, a water purification system V as still another embodiment will be described with reference to FIG. 5. In FIG. 5, components represented by the same reference numerals as found in FIGS. 1, 3 and 4 have the same or similar functions as those of components in FIGS. 1, 3 and 4 which are represented by the reference numerals. The water purification system V in the present embodiment comprises a reservoir 10 for reserving polluted ground water as for-treatment water, an ion exchange resin (in the present embodiment, anion exchange resin) 30 as concentration means for carrying out a step of concentrating a nitrogen compound in for-treatment water, a nitrogen treatment device 1 as nitrogen treatment means for carrying out a nitrogen treatment step, and a pump 20 as returning means for carrying out a step of returning for-treatment water treated in the nitrogen treatment device 1 to the ion exchange resin 30.

The reservoir 10 is connected to an ion exchange vessel 31 having the ion exchange resin 30 by a pipe 12. Further, to the vessel 31, a pipe 15 for discharging water purified by the ion exchange resin 30 out of the system is connected. To the vessel 31 is also connected a pipe 32 for supplying restoration water for replacing nitrate nitrogen or ammonia nitrogen stuck to the ion exchange resin 30 with chloride ions when the ion exchange ability of the ion exchange resin 30 is lowered. In addition, to the vessel 31, a pipe 16 for transferring restoration water used for ion exchange in a manner to be described in detail later to the nitrogen treatment device 1 is connected.

To the nitrogen treatment device 1, a pipe 17 for discharging denitrified for-treatment water out of the system is connected. Further, to the nitrogen treatment device 1, a pipe 21 is also connected. The pipe 21 is connected, via the pump 20, to the pipe 12 which connects the reservoir 10 to the vessel 31.

In the present embodiment, firstly, in the concentration step, for-treatment water reserved in the reservoir 10 is transferred to the vessel 31 having the ion exchange resin 30 via the pipe 12 so as to exchange nitrate ions, nitrite ions or ammonium ions contained in low concentrations in the for-treatment water with ions in the ion exchange resin 30. As a result, for-treatment water with a nitrate nitrogen content of 10 to 20 mg/L which is treated in an amount of, for example, 100 tons per day is discharged out of the system via the pipe 15 as 98 tons of purified water containing 1 to 5 mg/L of nitrate nitrogen.

Consequently, the water purified by the ion exchange resin 30 in the concentration step can satisfy the water quality standard that the content of nitrate nitrogen must be not higher than 10 mg/L and can be provided as drinking water.

Meanwhile, when the ion exchange ability of the ion exchange resin 30 in the vessel 31 is lowered due to the ion exchange with the for-treatment water, restoration water containing a high concentration of sodium chloride as means for restoring the ion exchange resin 30 is introduced into the vessel 31 via the pipe 32. As a result, nitrate ions, nitrite ions or ammonium ions stuck to the ion exchange resin 30 are exchanged with chloride ions in the restoration water, thereby restoring the ion exchange ability of the ion exchange resin 30. Then, the used restoration water containing the nitrate ions or other ions exchanged with the chloride ions is sent to the nitrogen treatment device 1 via the pipe 16 as concentrated for-treatment water.

A description about details of the technique will be omitted herein since it is already disclosed on pages 145 to 148 of “Unit Operations for Removal of Nitrogen and Phosphorus” in “Research Report on Technique for Prevention of Eutrophication in Closed Expanse of Water, 1997, Rational Technique for Treatment of Nitrogen and Phosphorus in Industrial Waste Water”.

When for-treatment water containing 10 to 20 mg/L of nitrate nitrogen is treated in an amount of, for example, 100 tons per day as described above, 2 tons of concentrated for-treatment water containing 200 to 1,000 mg/L of nitrate nitrogen is sent to the nitrogen treatment device 1 via restoration water. Further, in this concentrated for-treatment water, chloride ions which have originally been contained in the polluted ground water and chloride ions which have originally been contained in the restoration water and have not been subjected to ion exchange are present.

As in the foregoing embodiments, in the nitrogen treatment device 1, when a controller turns on a power supply 7 so as to energize a cathode 6 and an anode 5 in the nitrogen treatment step, nitrate ions contained in the for-treatment water concentrated as described above are converted into nitrite ions through a reduction reaction at the cathode 6. Then, the nitrite ions produced through the reduction reaction of the nitrate ions are further converted into ammonia through another reduction reaction.

Meanwhile, on the anode 5 side, since at least chloride ions are contained in the concentrated for-treatment water as described above, hypochlorous acid and ozone or active oxygen are produced from the surface of the anode 5. As a result, ammonia in the concentrated for-treatment water is denitrified, thereby producing a nitrogen gas.

Thereby, the nitrogen compound in the concentrated for-treatment water containing 200 to 1,000 mg/L of nitrate nitrogen can be removed efficiently in the nitrogen treatment device 1, and the resulting for-treatment water whose content of nitrate nitrogen has been reduced to 10 to 30 mg/L by the nitrogen removal treatment can be discharged out of the system via the pipe 17.

Thus, unlike the prior art, the nitrogen compound such as nitrate nitrogen contained in the for-treatment water can be removed efficiently without adding a special additive such as methanol to the for-treatment water, so that ease of maintenance can be improved.

Further, since unlike the prior art, the nitrogen compound such as nitrate nitrogen is not treated by biological treatment, control of temperatures of bacteria and the like can be obviated, and the size of the water purification system itself can be reduced, so that costs can be reduced.

In addition to being discharged out of the system, the for-treatment water whose content of nitrate nitrogen has been reduced to 10 to 30 mg/L by the nitrogen removal treatment as described above may be sent to the pipe 12 which connects the reservoir 10 to the vessel 31, via the pipe 21 by the pump 20 as the returning means in the returning step. Since the pipe 21 is connected to the pipe 12 upstream from a sand filter 22 installed in the pipe 12, the for-treatment water sent through the pipe 21 is filtered in the sand filter 22 together with untreated for-treatment water sent from the reservoir 10, and the resulting for-treatment water is sent to the vessel 31 having the ion exchange resin 30.

Thus, the for-treatment water treated in the nitrogen treatment device 1 may not have to be discharged right out of the system, and the nitrogen compound such as nitrate nitrogen in the for-treatment water can be concentrated again in the vessel 31 via restoration water. As a result, the for-treatment water can be provided as purified water (or drinking water). Thereby, waste water which cannot be discharged out of the system as purified water can be recycled, so that water purification treatment suited for the environment can be implemented.

Further, the for-treatment water to be sent to the vessel 31 having the ion exchange resin 30 can be concentrated and separated after sterilized with hypochlorous acid in advance, so that purified water can be provided in a sanitarily favorable condition.

Further, when iron ions or manganese ions are contained in the polluted ground water as the for-treatment water to be treated in the present embodiment, the for-treatment water is transferred to the nitrogen treatment device 1 with the ions contained therein since the ion exchange resin 30 in the present embodiment is not capable of collecting cations.

Since a large amount of hypochlorite is contained in the for-treatment water to be discharged from the nitrogen treatment device 1 as described above, the iron ions and manganese ions react with these hypochlorites (as shown by the above reaction formulae D and E) so as to produce iron hydroxide (III) which is hardly soluble in water and hydrated manganese dioxide.

Then, the for-treatment water containing iron hydroxide (III) and hydrated manganese dioxide is sent to the pipe 12 connecting the reservoir 10 to the vessel 31, by the pump 20 via the pipe 21. Then, together with untreated for-treatment water transferred from the reservoir 10, the for-treatment water is filtered in the sand filter 22 so as to remove iron and manganese. Thereby, the iron ions and manganese ions contained in the for-treatment water can also be removed efficiently, so that the efficiency of purification of for-treatment water can be improved.

In the foregoing embodiments, since the halide ions contained the for-treatment ions are chloride ions, hypohalogenous acid produced in the for-treatment water is hypochlorous acid. Alternatively, the halide ions may be fluoride ions or bromide ions. In this case, hypohalogenous acid produced in the for-treatment water is hypofluorous acid or hypobromous acid.

As described in detail above, according to the present invention, since a water purification system comprises concentration means for concentrating a nitrogen compound in for-treatment water containing the nitrogen compound and nitrogen treatment means for treating the nitrogen compound in the for-treatment water treated in the concentration means and containing at least halide ions by an electrochemical process, the nitrogen compound in the for-treatment water can be removed and concentrated in the concentration means, and the resulting for-treatment water free from the nitrogen compound can be discharged as purified water or drinking water.

Further, in the for-treatment water concentrated by the concentration means and containing at least halide ions, hypohalogenous acid can be produced by an electrochemical process in the nitrogen treatment means. Thereby, the nitrogen compound can be removed efficiently.

Accordingly, unlike the prior art, the nitrogen compound such as nitrate nitrogen contained in the for-treatment water can be removed efficiently without adding a special additive such as methanol to the for-treatment water, so that ease of maintenance can be improved.

Further, according to the present invention, since the nitrogen compound such as nitrate nitrogen is not treated by biological treatment, control of temperatures of bacteria and the like can be obviated, and the size of the system itself can be reduced, so that costs can be reduced.

Further, since the water purification system of the present invention comprises returning means for returning the for-treatment water treated by the nitrogen treatment means to the concentration means, the for-treatment water treated by the nitrogen treatment means can be treated by the concentration means again without being discharged as it is, so that water purification treatment suited for the environment can be implemented.

Further, since at least halide ions are contained in the for-treatment water to be treated by the nitrogen treatment means, hypohalogenous acid is contained in the for-treatment water treated by the electrochemical process (electrolysis). Therefore, by returning the for-treatment water containing hypohalogenous acid to the concentration means by the returning means, for-treatment water to be treated in the concentration means can be sterilized. Consequently, the for-treatment water treated in the concentration means can be discharged as purified water or drinking water which is favorable from a sanitary standpoint.

Further, in that case, hypohalogenous acid is contained in the for-treatment water concentrated in the concentration means. Thus, even when halide ions are not contained in for-treatment water which is to be newly treated in the concentration means, the need for adding halide ions can be obviated, so that ease of maintenance can be improved.

Further, according to the present invention, since the nitrogen treatment means treats 200 to 500 mg/L of nitrate nitrogen contained in the for-treatment water as the nitrogen compound so as to adjust the content of nitrate nitrogen in the for-treatment water to 50 to 100 mg/L, denitrification can be carried out with high denitrification efficiency, so that the efficiency of the treatment can be further improved.

Further, according to the present invention, since the concentration means treats the nitrogen compound in the for-treatment water treated in filtration means, the nitrogen compound can be concentrated in the concentration means after solid components contained in the for-treatment water are removed in the filtration means, whereby ease of maintenance of the concentration means can be improved.

Further, when iron ions or manganese ions are contained in the for-treatment water, hypohalogenous acid produced in the nitrogen treatment means can react with the iron ions and manganese ions so as to produce an iron hydroxide which is hardly soluble in water and hydrated manganese dioxide. Thus, the iron ions and manganese ions contained in the for-treatment water can be removed by the filtration means as the iron hydroxide and hydrated manganese dioxide.

Further, according to the present invention, since the concentration means comprises an electrodialyser, the nitrogen compound contained in the for-treatment water can be concentrated easily and continuously.

Further, according to the present invention, since the concentration means comprises reverse osmosis membrane equipment, the nitrogen compound contained in the for-treatment water can be concentrated easily and continuously.

Further, according to the present invention, since the concentration means comprises an ion exchange resin and means for restoring the ion exchange resin, for-treatment water containing a low concentration of nitrogen compound can be passed through the ion exchange resin so as to be discharged as purified water free from the nitrogen compound. Further, by passing restoration water through the ion exchange resin whose ion exchange ability has been lowered due to the nitrogen compound stuck thereto, the ion exchange ability of the ion exchange resin can be restored, and the used restoration water contains the nitrogen compound in high concentration. Thus, the nitrogen compound contained in the for-treatment water can be concentrated easily and continuously.

Further, according to the present invention, since a conductive material containing or covered with an element in the group Ib or IIb of the periodic table is used as a metallic material constituting a cathode of the nitrogen treatment means, and an insoluble material or carbon is used as a conductive material constituting an anode, reactions of reducing nitrate nitrogen in the for-treatment water to nitrite nitrogen and to ammonia can be accelerated so as to shorten time required for the reduction reactions, and even a low concentration of nitrogen compound can be removed. Thereby, the efficiency of the treatment of the nitrogen compound is improved.

Further, according to the present invention, since a water purification method comprises a concentration step of concentrating a nitrogen compound in for-treatment water containing the nitrogen compound and a nitrogen treatment step of treating the nitrogen compound in the for-treatment water treated in the concentration step and containing at least halide ions by an electrochemical process, the nitrogen compound in the for-treatment water can be removed and concentrated in the concentration step, and the resulting for-treatment water free from the nitrogen compound can be discharged as purified water or drinking water.

Further, in the for-treatment water concentrated in the concentration step and containing at least halide ions, hypohalogenous acid can be produced by an electrochemical process in the nitrogen treatment step. Thereby, the nitrogen compound can be removed efficiently.

Accordingly, unlike the prior art, the nitrogen compound such as nitrate nitrogen contained in the for-treatment water can be removed efficiently without adding a special additive such as methanol to the for-treatment water, so that ease of maintenance can be improved.

Further, according to the present invention, since the nitrogen compound such as nitrate nitrogen is not treated by biological treatment, control of temperatures of bacteria and the like can be obviated, so that costs can be reduced.

Further, since the water purification method of the present invention further comprises a returning step of returning the for-treatment water treated in the nitrogen treatment step to the concentration step, the for-treatment water treated in the nitrogen treatment step can be treated again in the concentration step without being discharged as it is, so that water purification treatment suited for the environment can be implemented.

Further, since at least halide ions are contained in the for-treatment water to be treated in the nitrogen treatment step, hypohalogenous acid is contained in the for-treatment water treated by the electrochemical process (electrolysis). Therefore, by returning the for-treatment water containing hypohalogenous acid to the concentration step in the returning step, for-treatment water to be treated in the concentration step can be sterilized. As a result, the for-treatment water treated in the concentration step can be discharged as purified water or drinking water which is favorable from a sanitary standpoint.

Further, in that case, hypohalogenous acid is contained in the for-treatment water concentrated in the concentration step. Thus, even when halide ions are not contained in for-treatment water which is to be newly treated in the concentration step, there is no need to add halide ions, so that ease of maintenance can be improved.

Further, according to the present invention, since 200 to 500 mg/L of nitrate nitrogen contained in the for-treatment water as the nitrogen compound is treated in the nitrogen treatment step so as to adjust the content of nitrate nitrogen in the for-treatment water to 50 to 100 mg/L, denitrification can be carried out with high denitrification efficiency, so that the efficiency of the treatment can be further improved.

Further, according to the present invention, since the nitrogen compound in the for-treatment water treated in a filtration step is treated in the concentration step, the nitrogen compound can be concentrated in the concentration step after solid components contained in the for-treatment water are removed in the filtration step, whereby ease of maintenance in the concentration step can be improved.

Further, when iron ions and manganese ions are contained in the for-treatment water, hypohalogenous acid produced in the nitrogen treatment step can react with the iron ions and manganese ions so as to produce an iron hydroxide which is hardly soluble in water and hydrated manganese dioxide. Thus, the iron ions and manganese ions contained in the for-treatment water can be removed in the filtration step as the iron hydroxide and hydrated manganese dioxide.

Further, according to the present invention, since the concentration step is carried out by means of an electrodialyser, the nitrogen compound contained in the for-treatment water can be concentrated easily and continuously.

Further, according to the present invention, since the concentration step is carried out by means of reverse osmosis membrane equipment, the nitrogen compound contained in the for-treatment water can be concentrated easily and continuously.

Further, according to the present invention, since the concentration step comprises an ion exchange step of treating the nitrogen compound in the for-treatment water with an ion exchange resin and a restoration step of restoring the used ion exchange resin after completion of the ion exchange step, for-treatment water containing a low concentration of nitrogen compound can be passed through the ion exchange resin in the ion exchange step so as to be discharged as purified water free from the nitrogen compound. Further, in the restoration step, by passing restoration water through the ion exchange resin whose ion exchange ability has been lowered due to the nitrogen compound stuck thereto, the ion exchange ability of the ion exchange resin can be restored, and the used restoration water contains the nitrogen compound in high concentration. Thus, the nitrogen compound contained in the for-treatment water can be concentrated easily.

Further, according to the present invention, since a conductive material containing or covered with an element in the group Ib or IIb of the periodic table is used as a metallic material constituting a cathode in the nitrogen treatment step and an insoluble material or carbon is used as a conductive material constituting an anode in the nitrogen treatment step, reactions of reducing nitrate nitrogen in the for-treatment water to nitrite nitrogen and to ammonia can be accelerated so as to shorten time required for the reduction reactions, and even a low concentration of nitrogen compound can be removed. Thereby, the efficiency of the treatment of the nitrogen compound is improved.

What is claimed is:

1. A water purification system comprising:
concentration means for concentrating a nitrogen compound in for-treatment water containing the nitrogen compound,
nitrogen treatment means for treating the nitrogen compound in the for-treatment water treated by the concentration means by an electrochemical process, the for-treatment water containing at least halide ions, and
returning means for returning the for-treatment water treated by the nitrogen treatment means to the concentration means.

2. The system of claim 1, wherein the nitrogen treatment means treats 200 to 500 mg/L of nitrate nitrogen contained in the for-treatment water as the nitrogen compound so as to adjust the content of nitrate nitrogen in the for-treatment water to 50 to 100 mg/L.

3. The system of claim 1 or 2, wherein the concentration means treats the nitrogen compound in the for-treatment water treated in filtration means.

4. The system of claim 1, 2 or 3, wherein the concentration means comprises an electrodialyser.

5. The system of claim 1, 2 or 3, wherein the concentration means comprises reverse osmosis membrane equipment.

6. The system of claim 1, 2 or 3, wherein the concentration means comprises an ion exchange resin and means for restoring the ion exchange resin.

7. The system of claim 1, 2, 3, 4, 5 or 6, wherein as a metallic material constituting a cathode of the nitrogen treatment means, a conductive material containing or covered with an element in the group Ib or IIb of the periodic table is used, and as a conductive material constituting an anode, an insoluble material or carbon is used.

8. A water purification method comprising:
a concentration step of concentrating a nitrogen compound in for-treatment water containing the nitrogen compound,
a nitrogen treatment step of treating the nitrogen compound in the for-treatment water treated in the concentration step by an electrochemical process, the for-treatment water containing at least halide ions, and
a returning step of returning the for-treatment water treated in the nitrogen treatment step to the concentration step.

9. The method of claim 8, wherein in the nitrogen treatment step, 200 to 500 mg/L of nitrate nitrogen contained in the for-treatment water as the nitrogen compound is treated so as to adjust the content of nitrate nitrogen in the for-treatment water to 50 to 100 mg/L.

10. The method of claim 8 or 9, wherein in the concentration step, the nitrogen compound in the for-treatment water treated in a filtration step is treated.

11. The method of claim 8, 9 or 10, wherein the concentration step is carried out by means of an electrodialyser.

12. The method of claim 8, 9 or 10, wherein the concentration step is carried out by means of reverse osmosis membrane equipment.

13. The method of claim 8, 9 or 10, wherein the concentration step comprises:
an ion exchange step of treating the nitrogen compound in the for-treatment water with an ion exchange resin, and
a restoration step of restoring the used ion exchange resin after completion of the ion exchange step.

14. The method of claim 8, 9, 10, 11, 12 or 13, wherein in the nitrogen treatment step, as a metallic material constituting a cathode, a conductive material containing or covered with an element in the group Ib or IIb of the periodic table is used, and as a conductive material constituting an anode, an insoluble material or carbon is used.
